(19) United States
(12) Patent Application Publication
(10) Pub. No.: US 2014/0037985 A1
(43) Pub. Date: Feb. 6, 2014

(54) HIGH-STRENGTH TIN-PLATED BRONZE TIRE BEAD STEEL WIRE AND FABRICATING METHOD THEREOF

(71) Applicant: Yong Dou, Weifang (CN)

(72) Inventor: Yong Dou, Weifang (CN)

(73) Assignee: SHANDONG DAYE CO., LTD., Weifang (CN)

(21) Appl. No.: 13/978,404

(22) PCT Filed: Dec. 26, 2011
(86) PCT No.: PCT/CN11/84706

§ 371 Date: Jul. 5, 2013

(51) Int. Cl. B60C 15/04; C23C 28/02

(52) U.S. Cl. CPC B60C 15/04; B60C 9/0007; C23C 28/021
USPC 428/675; 205/140

(57) ABSTRACT

The present invention discloses a high-strength tin-plated bronze tire bead steel wire, which comprises a steel wire base body. The surface of the steel wire base body is provided with at least two plating layers, and the tin content of the plating layers decreases layer by layer from inside to outside. The plating layer directly adjoining the surface of the steel wire base body has a high tin content, the adhesive force between the plating layer and the steel wire base body is strong, and the plating layer which has a high tin content can more effectively prevent the steel wire base body from rusting. The plating layers with the tin content gradually decreasing from inside to outside are combined closely with each other, and a strong adhesive force exists between the outermost plating layer with the relatively lowest tin content and tire rubber.

### CROSS-REFERENCE TO RELATED APPLICATIONS

This application is the U.S. national phase of International Application No. PCT/CN2011/084706, filed on 26 Dec. 2011, the entire contents of which is hereby incorporated by reference.

### BACKGROUND OF THE INVENTION

1. Field of the Invention

The present invention relates to a steel wire, particularly a tire bead steel wire, and to a method for fabricating the tire bead steel wire.

2. Background of the Invention

With the development of automobile toward lightweight and high-speed, the radial tire, as an important part of automobile, has experienced a rapid application and development due to its advantages of high-speed, energy-saving, lightweight, long mileage, etc. The radial tire will bear acting forces such as stretching, compression, twisting and centrifugation during usage. The tire bead steel wire is one of the framework materials, and its quality poses a direct effect on the tire. The current commonly used tire bead steel wire is a steel wire in which tin-plated bronze is used to reinforce the edge of the tire. The tire is a steel wire bead which is weaved by a tire bead steel wire and an isolating rubber, so that the outer tire closely fastens to the rim.

During running of the automobile, the tire bead and the bead edge suffer from a large force. In case that there is a weak adhesive force between tire bead steel wire—a framework material constituting the bead and the tire rubber, the bead will easily loose, so that the tire bursts and a traffic accident follows.

In practical usage, the magnitude of the adhesive force between the tire bead steel wire and the tire rubber has a direct effect on the quality of the tire. During fabrication of tire bead steel wire, a bright surface of steel wire of the tire bead will cause a very weak adhesive force between the steel wire and the tire rubber. Currently in the industry of tire bead steel wire, the surface of steel wire has a tin bronze plating layer, mainly comprising bronze with a low content of tin. With the tin bronze layer on the surface of steel wire, the adhesive force between the tire bead steel wire and the tire rubber is enhanced, so as to realize a close coupling between the steel wire and the tire rubber, and make full use of the tire bead steel wire as a tire framework material. The stronger the adhesive force between the tire bead steel wire and the tire rubber is, the higher the safety of tire is. Nonetheless, in case the bronze with a low content of tin is used as a cathodic plating layer of the steel wire, upon rusting, the bronze with a low content of tin will not corrode, while the steel wire base body will corrode rapidly. As a result, the plating layer looses its function for protecting the steel wire base body, the bronze with a low content of tin peels off from the steel wire base body, and the tire bead steel wire can not bear the acting forces such as stretching, compression, twisting and centrifugation during running of an automobile, which easily results in that the bead looses, the tire bursts, and thus a traffic accident follows.

### BRIEF SUMMARY OF THE INVENTION

The technical problem to be solved by the present invention is to provide a high-strength tin-plated bronze tire bead steel wire which provides a strong adhesive force with the steel wire base body and the tire rubber.

In order to solve the above technical problem, the present invention proposes a technical solution which is a high-strength tin-plated bronze tire bead steel wire comprising a steel wire base body, wherein the surface of the steel wire base body is provided with at least two plating layers, and the tin content of the plating layers decreases layer by layer from inside to outside.

In a preferred embodiment, the innermost plating layer has a tin content of >3.0% and ≦20.0% of the total weight of the innermost plating layer, with the balance being copper and inevitable impurities.

In a preferred embodiment, the outermost plating layer has a tin content of >0.3% and ≦3.0% of the total weight of the outermost plating layer, with the balance being copper and inevitable impurities.

In a preferred embodiment, the surface of the steel wire base body is plated with two plating layers, the inner plating layer has a tin content of >3.0% and ≦20.0% of the total weight of the inner plating layer, and the outer plating layer has a tin content of >0.3% and ≦3.0% of the total weight of the outer plating layer.

Since the above technical solution is adopted, the high-strength tin-plated bronze tire bead steel wire comprises a steel wire base body, wherein the surface of the steel wire base body is provided with at least two plating layers, the tin content of the plating layers decreases layer by layer from inside to outside. The plating layer directly adjoining the surface of the steel wire base body has a high tin content, the adhesive force between the plating layer and the steel wire base body is strong, and the plating layer which has a high tin content can prevent more effectively the steel wire base body from rusting. The plating layers with the tin content gradually decreasing from inside to outside are combined closely with each other, and a strong adhesive force exists between the outermost plating layer with the relatively lowest tin content and the tire rubber. Therefore, the the tire bead steel wire of the present solution can not only guarantee the steel wire base body in the plating layer will not rust, but also a strong adhesive force between the tire bead steel wire and the tire rubber. As a result, the tire can bear high-strength acting forces such as stretching, compression, twisting and centrifugation during running of an automobile, and the driving safety is guaranteed.

Another technical problem to be solved by the present invention is to provide a method for fabricating a high-strength tin-plated bronze tire bead steel wire.

In order to solve the above technical problem, the present invention proposes a technical solution which is a method for fabricating a high-strength tin-plated bronze tire bead steel wire, comprising: arranging in sequence at least one electroplating tanks along the process route of the tire bead steel wire; arranging at least one electroless plating tanks behind the electroplating tanks; and passing the tire bead steel wire sequentially through the electroplating tanks and the electroless plating tanks, wherein the sum of the number of the electroplating tanks and the electroless plating tanks equals to the number of layers in the tire bead steel wire plating layers.

In a preferred embodiment, the plating layer formed in the electroplating tank has a tin content of >3.0% and ≦20.0% of the total weight of the plating layer, and the plating layer formed in the electroless plating tank has a tin content of >0.3% and ≦3.0% of the total weight of the plating layer.

Since the above technical solution is adopted, the method for fabricating a high-strength tin-plated bronze tire bead steel wire comprises: arranging in sequence at least one electroplating tanks along the process route of the tire bead steel wire; arranging at least one electroless plating tanks behind the electroplating tanks; and passing the tire bead steel wire sequentially through the electroplating tanks and the electroless plating tanks, wherein the sum of the number of the electroplating tanks and the electroless plating tanks equals to the number of layers in the tire bead steel wire plating layers. The tire bead steel wire passes through the electroplating tank and the electroless plating tank in the process route for one time, so that plating layers with a corresponding number of layer are formed on the surface of steel wire of the tire bead. By adjusting the concentrations and content ratio of various substances in the electroplating tank and the electroless plating tank, plating layers are formed on the surface of steel wire of the tire bead with the tin content decreasing layer by layer from inside to outside. The innermost layer plating layer has a high tin content, so that it can closely bind with the tire bead steel wire; while the outermost plating layer has a lower tin content than the inner layers to guarantee a strong adhesive force with the tire rubber.

### BRIEF DESCRIPTION OF THE DRAWINGS

FIG. 1 is a structural diagram of an embodiment of the present invention;

FIG. 2 is a structural diagram of the prior art;

FIG. 3 is a spectral plot of a surface roughness measurement in an embodiment of the present invention; and

FIG. 4 is a spectral plot of a surface roughness measurement in the prior art.

### LIST OF REFERENCE NUMERALS

1: steel wire base body;

2: inner plating layer;

3: outer plating layer; and

4: tire rubber.

### DETAILED DESCRIPTION OF THE INVENTION

The present invention will be further described with reference to the accompanying drawings and embodiments. In the following detailed description, some exemplary embodiments of the present invention are described only by way of illustration. It is apparent for the ordinary skilled in the art that modifications can be made in various manner to the embodiments as described above without departing from the spirit and scope of the present invention. Thus, the accompanying drawings and description are illustrative in nature, instead of limiting the protection scope of the claims.

A high-strength tin-plated bronze tire bead steel wire comprises a steel wire base body 1. The surface of the steel wire base body 1 is provided with at least two plating layers, and the tin content of the plating layers decreases layer by layer from inside to outside. The innermost plating layer has a tin content of >3.0% and ≦20.0% of the total weight of the plating layer, with the balance being copper and inevitable impurities. The outermost plating layer has a tin content of >0.3% and ≦3.0% of the total weight of the plating layer, with the balance being copper and inevitable impurities.

The present invention will be described hereinafter by taking a steel wire base body 1 being plated with two plating layers as an example.

As shown in FIG. 1, the high-strength tin-plated bronze tire bead steel wire comprises a steel wire base body 1. The surface of the steel wire base body 1 is sequentially plated with an inner plating layer 2 and an outer plating layer 3 from inside to outside. The inner plating layer 2 comprises tin of 3.0%-20.0% by weight, with the balance being copper and inevitable impurities. The outerer plating layer 2 comprises tin of 0.3%-3.0% by weight, with the balance being copper and inevitable impurities.

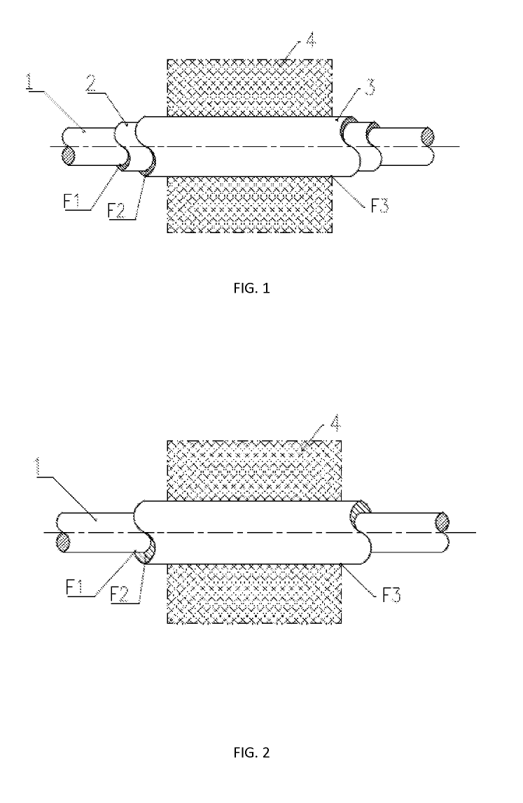

As shown in FIG. 2, a closely binding is required among the conventional plating layer on the tire bead steel wire, the steel wire base body 1, the plating layer on the surface of steel wire, and the tire rubber 4. The magnitude of the detected adhesive force is determined by three binding forces F1, F2, and F3, as shown in FIG. 2. In the conventional tire bead steel wire outer plating layer 3, the combination of these three forces is limited by factors like a process factor, and it is impossible to realize a very high binding strength. Thus, as far as the index of adhesive force between the tire bead steel wire and the tire rubber 4 is concerned, it is impossible to realize a very high adhesive strength.

In the present invention, an inner plating layer 2 and an outer plating layer 3 are formed, as shown in FIG. 1, which produces the following advantages.

[1] The adhesive force leads to the increase of F1 between the steel wire base body 1 and the plating layer on the surface of steel wire (i.e., the inner plating layer 2), the increase of F2 between the inner plating layer 2 and the outer plating layer 3, and the increase of F3 between the outer plating layer 3 and the tire rubber 4. Besides, the interaction among F1, F2, and F3 leads to a high index of adhesive force between the tire bead steel wire and the tire rubber 4, thus improving the safety of the tire.

[2] For the plating layers on the surface of steel wire of the tire bead, elements in the plating layer can be adjusted according to the proportion of the rubber formula from the tire factory, thus realizing the diversity of plating layers.

[3] The increase in surface roughness of the steel wire not only increases the adhesive force, but also enhances the adhesive force between the steel wire and the tire rubber 4, thus improving performance of the tire bead steel wire such as anti-oxidation, anti-corrosion, anti-aging, or the like in the tire.

[4] The inner plating layer 2 closely binds to the surface of the steel wire base body 1, thus protect the steel wire base body 1 from rusting. The inner surface of the outer plating layer 3 closely binds to the outer surface of the inner plating layer 2. Since a strong adhesive force is present between the outer plating layer 3 and the tire rubber 4, the tire bead steel wire in the present solution can not only guarantee the steel wire base body in the plating layer 1 will not rust, but also a strong adhesive force between the tire bead steel wire and the tire rubber 4. As a result, the tire can bear high-strength acting forces such as stretching, compression, twisting and centrifugation during running of an automobile, and the driving safety is guaranteed.

The difference in magnitude of adhesive force for the tire bead steel wire plating layer of the present invention and the conventional plating layer will be illustrated with experimental data.

The experimental conditions follow. The vulcanizing mold is 50 mm, the vulcanizing temperature is 151° C., and the vulcanizing duration is 40 min. With the rubber from a certain tire factory, the adhesive force experiments are performed on the conventional plating layer and the plating layer of the present solution under the same experimental conditions. The experiments show that the adhesive force of the multiple-element plating layer is 80% higher than that of the conventional plating layer, and the data are shown in the following table.

| | Data N | | | | | | | | |
|---|---|---|---|---|---|---|---|---|---|
| Plating layer | 1 | 2 | 3 | 4 | 5 | 6 | 7 | 8 | Average |
| conventional | 1240 | 1310 | 1355 | 1370 | 1370 | 1375 | 1315 | 1290 | 1328 |
| the present invention | 2580 | 2585 | 2595 | 2650 | 2634 | 2615 | 2648 | 2597 | 2613 |

As compared with the conventional plating layer surface of tire bead steel wire, the plating layer of tire bead steel wire according to the present invention has a larger surface roughness. This will be illustrated hereinafter with experimental data.

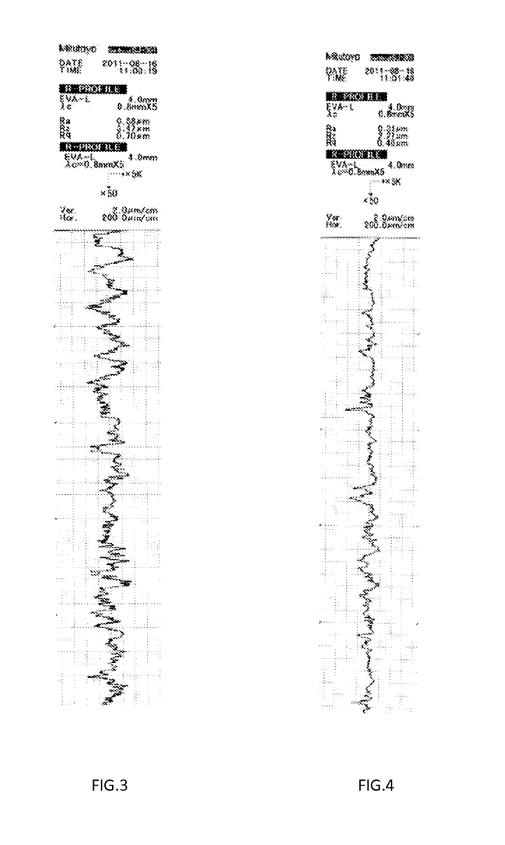

The experimental testing instrument is Automation Dr.SJ-301 surface roughness gauge. Experimental conditions follow. The steel wires of the same specification are drawn by the same machine. The conventional plating layer and the plating layer of the present invention are used for production. The detection are performed offline for comparisons. The surface of the multiple-element plating layer steel wire has a roughness larger than that of the conventional plating layer, as shown in FIGS. 3 and 4. The plating layer of the present invention shows a relatively large spectral fluctuation. This indicates that the plating layer of the present invention has a better surface roughness, which not only increases the adhesive force, but also favors the rate for the rubber to cover the steel wire.

The method for fabricating a high-strength tin-plated bronze tire bead steel wire will be introduced hereinafter.

A method for fabricating a high-strength tin-plated bronze tire bead steel wire comprises: arranging in sequence at least one electroplating tanks along the process route of the tire bead steel wire; arranging at least one electroless plating tanks behind the electroplating tanks; and passing the tire bead steel wire sequentially through the electroplating tanks and the electroless plating tanks, wherein the sum of the number of the electroplating tanks and the electroless plating tanks equals to the number of layers in the tire bead steel wire plating layers.

The plating layer formed in the electroplating tank has a tin content of >3.0% and ≦20.0% of the total weight of the plating layer, while the plating layer formed in the electroless plating tank has a tin content of >0.3% and ≦3.0% of the total weight of the plating layer. In other words, the tire bead steel wire is developed with electroplating layers with relatively high tin contents in the electroplating tanks By taking the tire bead steel wire as a center, the tin contents for these electroplating layers decrease sequentially from inside to outside, so that electroplating layers of the innermost layer closely bind to the tire bead steel wire, and the plating layers closely bind to each other. The tire bead steel wire is developed with electroless plating layers with a relatively low tin contents in the electroless plating tanks Similarly, the tin contents for these electroless plating layer decrease sequentially from inside to outside, so that the tin content of the outermost electroless plating layer will guarantee that the strongest adhesive force is present between the plating layer and the tire rubber.

By taking a tire bead steel wire with two plating layers as an example, the fabricating method therefor comprises the following steps.

Step 1: Along the process route, red copper and tin are put into the electroplating tank at a certain proportion, and copper sulfate and stannous sulfate are put into the electroless plating tank at a certain proportion.

Step 2: Along the process route, the tire bead steel wire with a clean surface is passed firstly through the electroplating tank, thereby forming an inner plating layer 2 with a tin content of >3.0% on the surface of the steel wire base body 1 by electroplating.

Step 3: Then, the electroplated tire bead steel wire is passed through the electroless plating tank, thereby forming an outer plating layer 3 with a tin content of <3.0% on the surface of the inner plating layer 2.

According to the method for fabricating a high-strength tin-plated bronze tire bead steel wire, the tire bead steel wire is firstly electroplated, so as to form the inner plating layer 2 on the surface of the steel wire base body 1. The inner plating layer 2 attached to the surface of the steel wire base body 1 protects the steel wire base body 1 from rusting. Then, an outer plating layer 3 is formed on the surface of the inner plating layer 2 by electroless plating. Since the electroless plating is advantageous in that the plating layer is uniform in thickness, has few pinholes, or the like, after electroless plating, the plating layer on the surface of steel wire of the tire bead is more uniform. In this way, the adhesive force between the tire bead steel wire and the tire rubber 4 is large and uniform, and can bear acting forces such as stretching, compression, twisting and centrifugation, and the driving safety is guaranteed.

The basic principles, major features, and advantages of the present invention have been shown and described as above. The skilled in the art will recognize that the present invention should not be limited to the above embodiments, and the above embodiments and the detailed description only illustrate the principles of the present invention. Various variations and modifications can be made to the present invention without departing from the spirit and scope thereof. Such variations and modifications fall within the scope of the present invention as claimed. The scope of the present invention is defined in the appended claims and equivalents thereto.

What is claimed is:

1. A high-strength tin-plated bronze tire bead steel wire, which comprises a steel wire base body, characterized in that:
the surface of the steel wire base body is provided with at least two plating layers; and
the tin content of the plating layers decreases layer by layer from inside to outside.

2. The high-strength tin-plated bronze tire bead steel wire of claim 1, characterized in that: the innermost plating layer has a tin content of >3.0% and ≦20.0% of the total weight of the innermost plating layer, with the balance being copper and inevitable impurities.

3. The high-strength tin-plated bronze tire bead steel wire of claim 1, characterized in that: the outermost plating layer has a tin content of >0.3% and ≦3.0% of the total weight of the outermost plating layer, with the balance being copper and inevitable impurities.

4. The high-strength tin-plated bronze tire bead steel wire of claim 1, characterized in that: the surface of the steel wire base body is plated with two plating layers, the inner plating layer has a tin content of >3.0% and ≦20.0% of the total weight of the inner plating layer, and the outer plating layer has a tin content of >0.3% and ≦3.0% of the total weight of the outer plating layer.

5. The high-strength tin-plated bronze tire bead steel wire of claim 2, characterized in that: the surface of the steel wire base body is plated with two plating layers, the inner plating layer has a tin content of >3.0% and ≦20.0% of the total weight of the inner plating layer, and the outer plating layer has a tin content of >0.3% and ≦3.0% of the total weight of the outer plating layer.

6. The high-strength tin-plated bronze tire bead steel wire of claim 3, characterized in that: the surface of the steel wire base body is plated with two plating layers, the inner plating layer has a tin content of >3.0% and ≦20.0% of the total weight of the inner plating layer, and the outer plating layer has a tin content of >0.3% and ≦3.0% of the total weight of the outer plating layer.

7. A method for fabricating a high-strength tin-plated bronze tire bead steel wire, characterized by comprising:
arranging in sequence at least one electroplating tanks along the process route of the tire bead steel wire;
arranging at least one electroless plating tanks behind the electroplating tanks; and
passing the tire bead steel wire sequentially through the electroplating tanks and the electroless plating tanks,
wherein the sum of the number of the electroplating tanks and the electroless plating tanks equals to the number of layers in the tire bead steel wire plating layers.

8. The method for fabricating a high-strength tin-plated bronze tire bead steel wire of claim 7, characterized in that:
the plating layer formed in the electroplating tank has a tin content of >3.0% and ≦20.0% of the total weight of the plating layer; and
the plating layer formed in the electroless plating tank has a tin content of >0.3% and ≦3.0% of the total weight of the plating layer.
